(19) United States
(12) Patent Application Publication
(10) Pub. No.: US 2025/0378977 A1
(43) Pub. Date: Dec. 11, 2025

(54) HIGH-STRENGTH R-T-B RARE EARTH PERMANENT MAGNET HAVING AMORPHOUS GRAIN BOUNDARY PHASE AND PREPARATION METHOD THEREFOR

(71) Applicant: ZHEJIANG INNUOVO MAGNETICS CO., LTD., Dongyang, Zhejiang Province (CN)

(72) Inventors: BIAO CHEN, DONGYANG, ZHEJIANG PROVINCE (CN); SONG FU, DONGYANG, ZHEJIANG PROVINCE (CN); XIAOLU YANG, DONGYANG, ZHEJIANG PROVINCE (CN); CONGYI WANG, DONGYANG, ZHEJIANG PROVINCE (CN); ZHAONENG ZHANG, DONGYANG, ZHEJIANG PROVINCE (CN); CHAO MAN, DONGYANG, ZHEJIANG PROVINCE (CN)

(21) Appl. No.: 18/877,260

(22) PCT Filed: May 25, 2023
(86) PCT No.: PCT/CN2023/096185

§ 371 Date: Dec. 19, 2024

(30) Foreign Application Priority Data
Nov. 10, 2022 (CN) 202211402354.X

(51) Int. Cl. H01F 1/057; C22C 33/00; C22C 45/00; H01F 7/02; H01F 41/02

(52) U.S. Cl. CPC H01F 1/0573; C22C 33/003; C22C 45/008; H01F 1/0576; H01F 1/0577; H01F 7/021; H01F 41/0266

(57) ABSTRACT

A high-strength R-T-B rare earth permanent magnet having an amorphous grain boundary phase includes: 29.0 wt. %-34.0 wt. % of large-atomic-radius elements with the atomic radius r satisfying r≥0.16 nm, said large-atomic-radius elements comprising 0.1 wt. %-0.8 wt. % of Mf, and Mf being any one or two of Zr and Mg; 1.05 wt. %-1.65 wt. % of small-atomic-radius elements with r≤0.12 nm, said small-atomic-radius elements comprising 0.8 wt. %-1.1 wt. % of boron element, and the total content C1 of the small-atomic-radius elements satisfying 0.25 wt. %≤[C1]−[B]≤0.55 wt. %; and the balance being medium-atomic-radius elements with 0.12 nm<r<0.16 nm and impurities, said medium-atomic-radius elements at least comprising 60.0 wt. % of TM, the TM being at least one of Fe and Co, and the content of other medium-atomic-radius elements except said TM being ≥0.2 wt. %. In the present invention, the proportion of the amorphous grain boundary phase in the grain boundary phase of the magnet is increased to 20 vol. % or more, thereby improving the capability of resisting crack propagation of the grain boundary phase of the magnet, and manufacturing a high-strength R-T-B rare earth permanent magnet.

### TECHNICAL FIELD

The present invention relates to a high-strength R-T-B rare earth permanent magnet having an amorphous grain boundary phase and a preparation method therefor, and belongs to the field of rare earth magnets.

### BACKGROUND TECHNOLOGY

A R-T-B rare earth permanent magnet is a type of permanent magnet material with superior magnetic performance. Compared with other permanent magnet materials, it has the highest maximum magnetic energy product and is widely used in modern industry. In recent years, with the expansion of the application scope of the R-T-B rare earth permanent magnet, especially in high-speed and high torque motors, the requirements for the mechanical performance of magnets have become increasingly high.

The microstructure of the R-T-B rare earth permanent magnet comprises a main phase R₂T₁₄B and a grain boundary phase, wherein the main phase is an intermetallic compound with a complex structure and a high strength. The grain boundary phase mainly includes two types: one is a triangular grain boundary phase distributed between the grains of the three main phases, and the other is a thin layer grain boundary phase distributed between the grains of the two main phases. At present, in the preparation process of a R-T-B magnet, in order to pursue a high coercivity of the magnet, a high content of low melting point elements are usually added to the magnet, and the grain boundary phase of the magnet is transformed into an FCC structure with high wettability compared with the main phase through tempering. However, the grain boundary phase strength of this structure is low, and its ability to resist crack propagation is poor. When the magnet is subjected to stress, cracks are prone to propagate along the grain boundary phase, leading to intergranular fracture of the magnet. Therefore, improving the strength of the grain boundary phase of the magnet and enhancing their ability to resist crack propagation through certain methods is an effective way to improve the mechanical performance of the magnet.

Amorphous alloy is a form of material formed when atoms do not have enough time to arrange and crystallize in an orderly manner during alloy solidification. The formation of an amorphous material requires the suppression of atomic ordering arrangement. Therefore a certain degree of undercooling is required in the solidification process. In addition, increasing the amorphous formation ability of the liquid grain boundary phase through a reasonable composition design is crucial for the formation of the amorphous material. Generally speaking, as the number of constituent elements increases, the amorphous formation ability of the alloy becomes stronger, because the increase in the number of constituent elements will suppress the formation of a completely crystalline phase during the cooling process. When designing amorphous compositions, three empirical criteria are usually followed: the number of the constituent elements is more than three; there is a significant difference in atomic size among the three main elements; and the mixing enthalpy between the three main elements is negative. By rational composition design, the amorphous formation ability of the alloy can be enhanced, and combined with a higher degree of undercooling during solidification, the alloy can be effectively transformed into an amorphous state.

Compared with traditional crystalline materials, the amorphous material has many special performance. For example, when a substance is amorphous, its strength is significantly higher than that of its crystalline state, and its corrosion resistance and oxidation resistance are also higher than those of a crystalline material. Therefore, through certain process methods, the grain boundary phase of the magnet can be transformed into an amorphous state, enhancing the strength of the grain boundary phase and improving its ability to resist crack propagation, and it can be expected that a high-strength R-T-B rare earth permanent magnet can be prepared.

### SUMMARY OF THE INVENTION

The present invention provides a method for preparing a high-strength R-T-B rare earth permanent magnet in response to the phenomenon of low grain boundary phase strength and easy crack propagation along the grain boundary phase under stress, resulting in poor mechanical performance of the magnet. According to the design principles of an amorphous alloy, three types of elements with different atomic radii are included in the elements that are prone to segregation at the grain boundary phase of the R-T-B magnet, namely: large-atomic-radius elements with atomic radius r≥0.16 nanometer (nm), medium-atomic-radius elements with atomic radius 0.12 nm<r<0.16 nm, and small-atomic-radius elements with atomic radius r≤0.12 nm. When the grain boundary phase contains three elements with different atomic radii and the concentration ratio is within a certain range, its amorphous formation ability will be significantly improved. Therefore, after a second stage aging, the amorphous state can also be transformed into an amorphous state at a slower cooling rate. The high strength of an amorphous grain boundary phase can enhance the mechanical performance of the R-T-B magnet.

The technical solution adopted by the present invention is as follows:
a high-strength R-T-B rare earth permanent magnet having an amorphous interfacial phase, wherein the composition of the magnet comprises:
29.0 wt. %-34.0 wt. % of large-atomic-radius elements having the atomic radius r satisfying r≥0.16 nm, wherein the large-atomic-radius elements comprise three or more of Nd, Pr, Dy, Tb, Ho, La, Ce, Gd, Er, Mg, and Zr, and the large-atomic-radius elements comprise 0.1 wt. %-0.8 wt. % of Mf, and Mf is any one or two of Zr and Mg; and
1.05 wt. %-1.65 wt. % of small-atomic-radius elements having the atomic radius r satisfying r≤0.12 nm, wherein the small-atomic-radius elements comprise three or more of S, C, H, N, O, F, and B and comprise 0.8 wt. %-1.1 wt. % of boron element; and the total content C1 of the small-atomic-radius elements satisfies 0.25 wt. %≤[C1]−[B]≤0.55 wt. %, wherein [C1] and [B] are C1 and B contents expressed as weight percentages.

That is, the total content of the small-atomic-radius elements except boron is 0.25 wt. %-0.55 wt. %, and preferably 0.3 wt. %-0.5 wt. %.

The balance are medium-atomic-radius elements having the atomic radius r satisfying 0.12 nm<r<0.16 nm and other unavoidable impurities, the medium-atomic-radius elements comprise three or more of Fe, Co, Ti, Al, Nb, Zn, Ga, W, Mn, Mo, V, Si, P, and Cu, the medium-atomic-radius elements at least comprise 60.0 wt. % of TM, the TM is at least one of Fe and Co, the content of the medium-atomic-radius elements except the TM is ≥0.2 wt. %, and preferably, the content of the medium-atomic-radius elements except the TM is 0.2-1.5 wt. %.

All the mass percentage contents mentioned are based on the mass of the magnet.

The magnet comprises a main phase R₂T₁₄B and a grain boundary phase, and the grain boundary phase consists of a crystalline grain boundary phase and an amorphous grain boundary phase; and

when the amorphous grain boundaries are the same, they contain three types of elements having large, medium, and small atomic radii, and the number of the small-atomic-radius elements is ≥3, the number of the medium-atomic-radius elements is ≥3, and the number of the large-atomic-radius elements is ≥3.

Furthermore, the proportion of the amorphous grain boundary phase in the grain boundary phase of the magnet is 20 vol. % (volume ratio) or more.

Furthermore, the content of the large-atomic-radius elements in the amorphous grain boundary phase of the magnet is 30 wt. %-70.0 wt. %, and the large-atomic-radius elements comprise 0.2 wt. %-10.0 wt. % of Mf, the content of the medium-atomic-radius elements is 20.0 wt. %-65.0 wt. %, and the content of the small-atomic-radius elements is 1.0 wt. %-15.0 wt. %. The mass percentage contents here are all based on the mass of the amorphous grain boundary phase of the magnet.

Furthermore, the medium-atomic-radius elements are preferably three or more of Fe, Co, Al, Nb, Ga, and Cu, the medium-atomic-radius elements comprise at least 60.0 wt. % of TM, and the TM is at least one of Fe and Co; and preferably, more than 85 wt. % of TM is Fe.

Furthermore, the high-strength R-T-B rare earth permanent magnet having an amorphous grain boundary phase is prepared by one of the following methods:
(1) the magnet does not comprise Mg element: SC strips are melted and spun according to a composition ratio, an alloy powder is prepared by hydrogen decrepitation and jet milling, the alloy powder is mixed with a powder comprising small-atomic-radius elements, the mixed powder is press-molded in an oriented magnetic field, and isostatically pressed to prepare a compact, and the compact is vacuum-sintered and subjected to first stage aging and second stage aging to prepare the R-T-B rare earth permanent magnet having an amorphous boundary phase; and
(2) the magnet comprises Mg element: SC strips are melted and spun according to a composition ratio of elements except Mg, an alloy powder is prepared by hydrogen decrepitation and jet milling, the alloy powder is mixed with a Mg particulate and a powder comprising small-atomic-radius elements, and the mixed powder is press-molded in an oriented magnetic field and isostatically pressed to prepare a compact, and the compact is vacuum-sintered and subjected to first stage aging and second stage aging to prepare the R-T-B rare earth permanent magnet having an amorphous boundary phase;
the powder comprising the small-atomic-radius elements is one or more of powders comprising S, C, O, or F elements, the powder comprising S, C, O, or F elements is generally an intermediate alloy powder and/or compound powder comprising S, C, O, or F elements, and the intermediate alloy powder and/or compound powder comprising S, C, O, or F elements is generally an intermediate alloy powder and/or compound powder comprising S, C, O, or F elements and Fe or rare earth elements;
the particle size of the powder comprising the small-atomic-radius elements is within 500 nm, and preferably within 100 nm; and
preferably, the powder comprising the small-atomic-radius elements is one or more of FeS, Nd₂O₃, Fe₃C, terbium fluoride, and dysprosium fluoride.

More preferably, the amount of FeS is 0.2-0.5%, and preferably 0.2-0.3 wt. % of the mass of the alloy powder, the amount of Nd₂O₃ is 0.2-0.6%, and preferably 0.3-0.5 wt. % of the mass of the alloy powder, and the amount of Fe₃C is 0.1-0.3%, and preferably 0.1-0.2 wt. % of the mass of the alloy powder.

In the method (2), the Mg particulate is a pure metal particle or a magnesium oxide particle.

The particle size of the Mg particulate is within 500 nm, and preferably within 100 nm.

In the method (1) or the method (2), the mixed powder is preferably added with an organic additive and then press-molded in an oriented magnetic field; the organic additive is one or more of a lubricant and an antioxidant, and the lubricant and antioxidant can be a conventional commercially available magnetic powder protection lubricant or antioxidant. The amount of the lubricant added can be 0.05-0.1% of the mass of the alloy powder, and the amount of the antioxidant can be 0.05-0.15% of the mass of the alloy powder.

The organic additive will produce residual carbon element in the magnet after sintering, usually ranging from 400 to 1000 ppm. Even if an excessive organic additive is added, it will not significantly increase the C content of the magnet, as the majority of the organic additive will evaporate during sintering. In addition, H, N, and O elements will also remain in the magnet. H element comes from the hydrogen decrepitation step, and N element comes from a nitrogen carrier gas of the jet milling. However, the residual content of H element is generally very small, basically between 2-10 ppm, and is generally negligible. The residual amount of N element in the magnet is also basically fixed, generally between 200-400 ppm. In addition, oxidation is inevitable during the preparation process of the magnet, which can also cause a certain degree of oxygen residue. The residual amount of oxygen is basically between 500-1300 ppm.

Therefore, in the method (1) or the method (2), if no small-atomic-radius element powder is added and the magnet is prepared according to a conventional process, three small-atomic-radius elements O, N, and C will remain fixed in the magnet (the residual amount of H atoms is negligible), which meets the requirement of comprising three or more types of the small-atomic-radius elements in the magnet. The sum of residual contents of O, N and C elements is approximately 0.11-0.27 wt. %, but the residual amount is limited by process conditions and can fluctuate. Usually, the residual amount is mostly distributed around 0.2 wt. %, and is difficult to control, and it is difficult to ensure that the residual amount reaches 0.25 wt. % or more each time. If the small-atomic-radius element powder is not additionally added, it is likely that the total content of the small-atomic-radius elements except boron element cannot meet the content requirement of 0.25 wt. %-0.55 wt. %. Therefore, in the preparation method of the present invention, preferably, a powder comprising the small-atomic-radius elements is added to the alloy powder, ensuring that the content of the small-atomic-radius elements except B reaches 0.25 wt. % or more.

However, an increase in the content of H and N elements can lead to a deterioration in the magnetic performance of the magnet, so an alloy or compound powder comprising H and N elements are generally not added additionally. Usually, a powder comprising S, C, O, or F elements is added.

In the method, it is preferred to cool at a cooling rate of ≥60° C./min after the second stage aging. Generally, a cold air fan is used for low-temperature air cooling. The preferred cooling rate after the second stage aging is 60-100° C./min.

With the increase of the number of constituent elements in the alloy, the amorphous formation ability of the alloy becomes stronger, because the increase of the number of the constituent elements will suppress the formation of a completely crystalline phase during the cooling process. Usually, in order to enhance the amorphous formation ability of the alloy, it is required that the number of alloy constituent elements be greater than three and there is a significant difference in atomic size between the three main elements. The present invention designs the alloy composition based on the design principles of amorphous alloys, so that the elements that are prone to segregation at the grain boundary phase of the R-T-B magnet contain three elements having different atomic radii: large, medium, and small radii. When the grain boundary phase contains three elements having different atomic radii and the concentration ratio is within a certain range, its amorphous formation ability will be significantly improved. Therefore, after second stage aging, an amorphous state can also be obtained at a slower cooling rate. The high strength of an amorphous grain boundary phase can significantly improve the mechanical performance of the R-T-B magnet.

The atomic radius of rare earth elements is relatively large, and in the present invention, the rare earth elements are added in a ratio exceeding the atomic stoichiometry of the main phase, so some rare earth elements may exist in the grain boundary phase. By increasing the types of the rare earth elements, it is possible to ensure the simultaneous presence of several different large-atomic-radius elements in the grain boundary phase. At the same time, the present invention has found that the segregation of Zr and Mg in the large-atomic-radius elements in the grain boundary phase can significantly enhance the amorphous formation ability of the liquid grain boundary phase. After adding a certain amount of Zr and

Mg to the alloy, the proportion of the amorphous grain boundary phase significantly increases after the second stage aging. Therefore, in the present invention, the large-atomic-radius elements contain 0.1 wt. %-0.8 wt. % of Zr and Mg. Due to the low boiling point of Mg, adding Mg during a melting process can cause excessive volatilization. Therefore, when the alloy contains Mg element, it is added by mixing its pure metal or an oxide particle with a magnetic powder.

The small-atomic-radius elements can significantly increase the viscosity of the liquid alloys. Therefore, the presence of a certain concentration of the small-atomic-radius elements in the alloys can greatly enhance the amorphous formation ability of the liquid grain boundary phase, thereby hindering the formation of the crystalline phase during cooling. The boron element in the small-atomic-radius elements needs to participate in the formation of the main phase, so the content of the small-atomic-radius elements in the present invention is 1.05 wt. %-1.65 wt. %, and the small-atomic-radius elements comprise 0.8 wt. %-1.1 wt. % of boron. In addition, the small-atomic-radius elements, due to their small atomic size, are prone to solid-dissolving in the main phase grains of the magnet. The segregation concentration of the small-atomic-radius elements added during the melting stage is relatively low in the grain boundary phase. Therefore, in the present invention, a nanometer-scale powder particle containing small-atomic-radius elements is mixed with the jet-milled magnetic powder to ensure that most of the small-atomic-radius elements can be enriched in the grain boundary phase of the magnet. Increasing the viscosity of the liquid grain boundary phase to enhance its amorphous formation ability can promote the transformation of the liquid grain boundary phase into an amorphous state after second stage aging. The mechanical performance of the magnet is improved by means of the high strength of the amorphous grain boundary. In the small-atomic-radius elements of the present invention, the boron element is added in the form of ferroboron during the melting stage, and part of the boron element exceeding the stoichiometric ratio of the main phase will be enriched in the grain boundary phase of the magnet. Other small-atomic-radius elements are mixed with the jet-milled magnetic powder in the form of an intermediate alloy powder or compound powder of Fe or rare earth elements, or a mixed powder of the two powders. To ensure that the small-atomic-radius elements can be fully enriched in the grain boundary phase, the particle size of the small-atomic-radius elements is within 500 nm, and preferably within 100 nm.

Among the medium-atomic-radius elements, Fe and Co need to participate in the formation of the main phase, and therefore at least 60.0 wt. % of Fe and Co are included in the present invention, and Fe and Co exceeding the stoichiometric ratio of the main phase will accumulate in the grain boundary phase of the magnet. In addition, in order to further improve the amorphous formation ability of the liquid grain boundary phase, it is necessary to add other medium-atomic-radius elements to ensure that the grain boundary phase contains three or more types of medium-atomic-radius elements. The content of the medium-atomic-radius elements except TM in the magnet should be ≥0.3 wt. %.

In theory, all substances can form amorphous materials when the cooling rate is fast, but it is difficult to achieve high-speed cooling of bulk materials in actual production processes. Therefore, it is necessary to reduce the cooling rate requirement during an amorphization process by increasing the amorphous formation ability of an alloy. When the amorphous formation ability of a liquid alloy is high, it can also form an amorphous material at lower cooling rates. By regulating the composition of the grain boundary phase alloy in the present invention, the amorphous formation ability of the liquid grain boundary phase can be significantly enhanced. Therefore, after the second stage aging, the grain boundary phase that meets the required composition requirements can also be transformed into an amorphous state at lower cooling rates. However, increasing the cooling rate appropriately can increase the proportion of the amorphous grain boundary phase. Therefore, in the present invention, it is preferred to cool at a cooling rate of ≥60° C./minute after the second stage aging.

The beneficial effects of the present invention are reflected in the fact that, based on the design principles of an amorphous alloy, the elements that are prone to segregation at the grain boundary phase of the R-T-B magnet simultaneously contain three types of elements having different atomic radii: large, medium, and small radii. When the grain boundary phase contains three elements having different atomic radii and the concentration ratio is within a certain range, its amorphous formation ability will be significantly improved. Therefore, after second stage aging, an amorphous state can also be obtained at a slower cooling rate. The proportion of the amorphous grain boundary phase in the grain boundary phase of the magnet of the present invention is increased to 20 vol. % (volume ratio) or more. By utilizing the significantly higher strength of an amorphous material compared to a crystalline material of the same composition, the ability of the magnetic grain boundary to resist crack propagation is improved, resulting in a high-strength R-T-B rare earth permanent magnet. The bending strength of the magnet of the present invention can reach 560 MPa or more, which is more than 20% higher than the existing technology.

### BRIEF DESCRIPTION OF THE DRAWINGS

FIG. 1(a) shows a bright field image of the grain boundary phase of the magnet in Experiment No. 2, and [0039] FIG. 1(b) and [0039] FIG. 1(c) are diffraction patterns of a triangular grain boundary phase (region \textcircled{1} in FIG. a) between three main phases and the thin layer grain boundary phase (region \textcircled{2} in FIG. a) between two main phases, respectively.

FIG. 2(a) shows a bright field image of the grain boundary phase of the magnet in Experiment No. 6, and [0040] FIG. 2(b) and [0040] FIG. 2(c) are diffraction patterns of a triangular grain boundary phase (region \textcircled{1} in FIG. a) between three main phases and a thin layer grain boundary phase (region \textcircled{2} in FIG. a) between two main phases, respectively.

FIG. 3(a) shows a bright field image of the grain boundary phase of the magnet in Experiment No. 10, and [0041] FIG. 3(b) and [0041] FIG. 3(c) are diffraction patterns of a triangular grain boundary phase (region \textcircled{1} in FIG. a) between three main phases and a thin layer grain boundary phase (region \textcircled{2} in FIG. a) between two main phases, respectively.

FIG. 4(a) shows the fracture morphology of the magnet in Experiment No. 6, and FIG. 4(b) is a local magnified image.

FIG. 5(a) shows the fracture morphology of the magnet in Experiment No. 10, and FIG. 5(b) is a local magnified image.

FIG. 6(a) shows a bright field image of the grain boundary phase of the magnet in Experiment No. 20, and FIG. 6(b) shows a diffraction pattern of a triangular grain boundary phase (region \textcircled{1} in FIG. a) between three main phases.

### DETAILED DESCRIPTION OF THE INVENTION

The present invention used vacuum induction melting and strip spinning to prepare alloy SC strips. Raw materials with a purity of 99.9 wt. % or higher were taken according to a distribution ratio and placed in a crucible in order of melting point from high to low. The furnace was evacuated until the vacuum degree reached 10⁻³-10⁻⁴ Pa and the dew point was below −50° C. Afterwards, the furnace was filled with argon gas to reach a pressure of 30-50 kPa, and heated to 1480-1510° C. The raw materials were completely melted, and then kept at this temperature for 3-5 min. Afterwards, the temperature of an alloy liquid was lowered to 1440-1460° C., kept at this temperature, and casted. The rotational speed of a copper roller was adjusted to 70-75 revolutions per minute, then the crucible was rotated at a certain speed to transport the molten alloy liquid through an intermediate package to a cooling roller for solidification, and then the resultant was dropped onto a water-cooled plate for cooling.

An alloy powder was prepared from SC strips by hydrogen decrepitation and jet milling. During the hydrogen decrepitation treatment, the hydrogen pressure inside a reaction vessel was generally 0.01-0.09 MPa. During a hydrogen absorption reaction, if the pressure inside the reactor changes by no more than 0.5% within 10 minutes, it indicated the end of hydrogen absorption. After the hydrogen absorption reaction was completed, the temperature was raised to 400-600° C. while vacuuming, and the temperature was kept for 2-6 h to remove hydrogen gas from the alloy strips. Then, a hydrogen decrepitation coarse powder was obtained by cooling. The obtained coarse powder was placed in a jet milling equipment, the nozzle pressure was adjusted to 0.6 MPa-0.8 MPa, and the coarse powder was driven to collide with each other through a high-speed gas for crushing. The gas used in the jet milling is an inert gas such as nitrogen, helium, and argon. A sorting wheel and a cyclone separator of the jet milling equipment were controlled to adjust the particle size of the powder.

After the jet milling, a magnetic powder and a powder containing the small-atomic-radius elements and a Mg element-containing powder (when the magnet contains Mg) were mixed evenly, and then a lubricant and an antioxidant were added to an alloy powder. The alloy powder was press-molded in an oriented magnetic field, and a conventional commercially available lubricant or antioxidant for magnetic powder protection could be used. The amount of the lubricant added could be 0.05-0.1% of the mass of the alloy powder, and the amount of the antioxidant could be 0.05-0.15% of the mass of the alloy powder.

The preferred orientation magnetic field was 3-6 T, and the molding pressure was 5-7 MPa. After oriented molding, a compact was subjected to cold isostatic pressing at a pressure of 150-180 MPa. After oriented molding, the compact density was 3.6-4.0 g/cm³, and after cold isostatic pressing, the compact density was about 4.6 g/cm³.

The magnet was sintered densely using a vacuum sintering process. The vacuum sintering process was as follows: the vacuum degree was 10⁻³-10⁻⁴ Pa, the sintering temperature was 1060-1120° C., and the temperature holding time was 4-20 h. After the temperature holding process was completed, it was cooled by air cooling.

The sintered magnet was subjected to first stage aging at 700-900° C. for 2-8 h. After the temperature holding process was completed, it was cooled by air cooling.

The magnet after the first stage aging was subjected to second stage aging at 400-650° C. for 2-8 h. After the temperature holding process was completed, it was cooled by air cooling, and preferably at a cooling rate of ≥60° C./min.

After crushing the magnet, samples were taken from a core, and ICP was used to detect the composition of the magnet. TEM was used to analyze the grain boundary phase structure of the magnet. TEM samples were prepared using the following method: the samples were polished with a sandpaper to a thickness of 30-40 μm and then subjected to ion thinning for less than 2 h; and alternatively, the samples could be ground and polished and prepared using FIB. EPMA was used to analyze the composition distribution of the magnet, and SEM was used to observe the microstructure of the magnet. The bending strength of the magnet was measured using a three-point bending method. Three-point bending samples were prepared by slicing the inner circle and double-sided grinding. The sample dimensions were 25 (±0.01) mm in length, 6 (±0.01) mm in width, and 5 (±0.01) mm in height. The height direction of the samples was parallel to the orientation direction of the magnet. The bending strength of 10 samples in each group was measured and the average value was calculated. A three-point bending indenter was a cylinder with a diameter of 5 mm, the diameter of two supporting columns was 5 mm, the span between support points was 14.5 mm, and the pressing speed of the indenter was 0.1 mm/min. The magnet was processed into a cylindrical shape with a diameter of φ10×10, wherein the height direction of the cylinder was the orientation direction of the magnet. A NIM magnetic performance tester was used to test the magnetic performance of the magnet.

### Example 1

Raw materials with a purity of 99.9 wt. % or higher were taken according to a composition ratio and placed in a crucible in order of melting point from high to low. The furnace was evacuated until the vacuum degree reached 10⁻³-10⁻⁴ Pa and the dew point was below −50° C. Afterwards, the furnace was filled with argon gas to reach a pressure of 30 kPa, and heated to 1490° C. The raw materials were completely melted, and then kept at this temperature for 3 min. Afterwards, the temperature of an alloy liquid was lowered to 1450° C., kept at this temperature, and casted. The rotational speed of a copper roller was adjusted to 70 revolutions per minute, then the crucible was rotated at a certain speed to transport the molten alloy liquid through an intermediate package to a cooling roller for solidification, and then the resultant was dropped onto a water-cooled plate for cooling to prepare SC strips with different compositions.

An alloy powder was prepared from the SC strips by hydrogen decrepitation and jet milling. During the hydrogen decrepitation treatment, the hydrogen pressure inside a reaction vessel was adjusted to 0.05 MPa. During a hydrogen absorption reaction, if the pressure inside the reactor changes by no more than 0.5% within 10 minutes, it indicated the end of hydrogen absorption. After the hydrogen absorption reaction was completed, the temperature was raised to 550° C. while vacuuming, and the temperature was kept for 3 h to remove hydrogen gas from the alloy strips. Then, a hydrogen crushed coarse powder was obtained by cooling. The obtained coarse powder was placed in a jet milling equipment, the nozzle pressure was adjusted to 0.6 MPa, and the coarse powder was driven to collide with each other through a high-speed gas for crushing. The gas used in the jet milling is nitrogen gas. A sorting wheel and a cyclone separator of the jet milling equipment were controlled to adjust the particle size SMD of the powder to 3.0 μm.

FeS, Nd₂O₃, and Fe₃C powder particles with a particle size of 100 nm were mixed into the jet-milled powder to obtain a mixed powder. The relative mass consumption of the three powder particles to the jet-milled powder was 0.3 wt. %, 0.5 wt. %, and 0.2 wt. %, respectively. 0.4 wt. % of a MgO powder particle was additionally mixed into the magnetic powder of Experiment No. 7 and Experiment No. 11, and the particle size was 100 nm.

After adding a lubricant and an antioxidant to the alloy powder, the alloy powder was press-molded in an oriented magnetic field using a conventional commercially available lubricant or antioxidant for protecting a magnetic powder. The lubricant used in the example was “Magnetic Powder Protective Lubricant 3# produced by Tianjin Yuesheng New Materials Research Institute”, and the antioxidant was “Neodymium Iron Boron Special Antioxidant 1# produced by Tianjin Yuesheng New Materials Research Institute”. The amount of the lubricant added was 0.08% of the mass of the alloy powder, and the amount of the antioxidant was 0.1% of the mass of the alloy powder.

The magnet was subjected to oriented molding with an orientation magnetic field of 5 T and a molding pressure of 5 MPa. After oriented molding, a compact was subjected to cold isostatic pressing at a pressure of 150 MPa. After oriented molding, the compact density was 3.6-4.0 g/cm³, and after cold isostatic pressing, the compact density was about 4.6 g/cm³.

The magnet was sintered densely using a vacuum sintering process. The vacuum sintering process was as follows: the vacuum degree was 10⁻³-10⁻⁴ Pa, the sintering temperature was 1090° C., the temperature holding time was 6 h, and after the temperature holding process was completed, it was cooled by air cooling.

The sintered magnet was subjected to first stage aging at an aging temperature of 880° C., and the temperature holding time was 3 h. After the temperature holding process was completed, it was cooled by air cooling.

The magnet after the first stage aging was subjected to second stage aging at an aging temperature of 520° C., and the temperature holding time was 3 h. After the temperature holding process was completed, low-temperature argon gas at −20° C. was introduced into the furnace, and a cold air fan was started for rapid cooling. The cooling rate of the magnet was 60-70° C./min.

After crushing the magnet, samples were taken from a core, and ICP was used to detect the composition of the magnet. TEM was used to analyze the grain boundary phase structure of the magnet. TEM samples were prepared using ion thinning and FIB, and the ion thinning time was less than 2 h. EPMA was used to analyze the composition distribution of the magnet, and SEM was used to observe the microstructure of the magnet. The bending strength of the magnet was measured using a three-point bending method. Three-point bending samples were prepared by slicing the inner circle and double-sided grinding. The sample dimensions were 25 (±0.01) mm in length, 6 (±0.01) mm in width, and 5 (±0.01) mm in height. The height direction of the samples was parallel to the orientation direction of the magnet. The bending strength of 10 samples in each group was measured and the average value was calculated. A three-point bending indenter was a cylinder with a diameter of 5 mm, the diameter of two supporting columns was 5 mm, the span between support points was 14.5 mm, and the pressing speed of the indenter was 0.1 mm/min.

The composition of the magnets of Experiment No. 1-Experiment No. 11 was shown in Table 1. The components of the magnets of each experiment group were expressed by mass percentages, where A₁ represented the total content of small-atomic-radius elements (O, S, H, N, and C) in the magnet except element B.

TABLE 1
Components of a magnet, unit: wt. %

| | | | | | | | | | | | | | | Component |
|---|---|---|---|---|---|---|---|---|---|---|---|---|---|---|
| No. | Nd | Pr | Dy | Mg | Zr | Fe | Co | Al | Nb | Ga | Cu | B | A₁ | requirements |
| 1 | 31.8 | / | / | / | / | Bal | / | / | / | / | / | 0.96 | 0.39 | Not satisfied |
| 2 | 31.8 | / | / | / | 0.2 | Bal | 0.3 | 0.2 | / | / | / | 0.96 | 0.39 | Not satisfied |
| 3 | 28.6 | 3.2 | / | / | 0.2 | Bal | / | / | 0.1 | / | / | 0.96 | 0.39 | Not satisfied |
| 4 | 28.6 | 3.2 | / | / | 0.2 | Bal | / | / | / | / | 0.1 | 0.96 | 0.39 | Not satisfied |
| 5 | 28.6 | 3.2 | 0.15 | / | / | Bal | 0.3 | 0.2 | 0.1 | 0.2 | 0.1 | 0.96 | 0.39 | Not satisfied |
| 6 | 28.6 | 3.2 | / | / | 0.05 | Bal | 0.3 | 0.2 | / | / | / | 0.96 | 0.39 | Not satisfied |
| 7 | 28.6 | 3.2 | / | 0.2 | / | Bal | 0.3 | 0.2 | / | / | / | 0.96 | 0.39 | Satisfied |
| 8 | 28.6 | 3.2 | / | / | 0.2 | Bal | 0.3 | 0.2 | / | / | / | 0.96 | 0.39 | Satisfied |
| 9 | 28.6 | 3.2 | / | / | 0.2 | Bal | 0.3 | / | / | 0.2 | / | 0.96 | 0.39 | Satisfied |
| 10 | 28.6 | 3.2 | 0.15 | / | 0.2 | Bal | 0.3 | 0.2 | / | 0.2 | / | 0.96 | 0.39 | Satisfied |
| 11 | 28.6 | 3.2 | 0.15 | 0.2 | 0.2 | Bal | 0.3 | 0.2 | 0.1 | 0.2 | 0.1 | 0.96 | 0.39 | Satisfied |

In the present example, the content of S, O, and C elements in the grain boundary phase of the magnet was adjusted by adding FeS, Nd₂O₃, and Fe₃C particles. However, due to the high chemical activity of the R-T-B powder, slight oxidation was inevitable during the preparation process of the magnet. In addition, the use of organic additives could also cause a certain degree of carbon residue, but these small-atomic-radius elements during the preparation process were mainly enriched in the grain boundary phase of the magnet; therefore, as long as the concentration range was within the recommended range of the present invention, the organic additives would also have beneficial effects. The powder preparation process involved a hydrogen crushing process, and after dehydrogenation, a certain amount of hydrogen would remain in the powder. However, after measurement, it was found that the hydrogen content was less than 3 ppm, and therefore the H content could be negligible.

The three-point bending method was used to test the bending strength of the magnet, and 10 data points were tested for each group and the average value was calculated. The results were shown in Table 2.

TABLE 2

| No. | 1 | 2 | 3 | 4 | 5 | 6 | 7 | 8 | 9 | 10 | 11 |
|---|---|---|---|---|---|---|---|---|---|---|---|
| Bending | 465 | 470 | 462 | 468 | 472 | 471 | 568 | 574 | 575 | 592 | 617 |
| strength | | | | | | | | | | | |
| (MPa) | | | | | | | | | | | |

From the bending strength data of the magnet, it could be determined that when the composition of the magnet did not meet the requirements of the present invention, namely, when the number and content of elements with different atomic radii were not met, the bending strength of the magnet was relatively low. And when the composition of the magnet met the requirements, the bending strength was significantly improved. Comparing Experiment No. 5-Experiment No. 7, it could be determined that when the magnet did not contain Zr or Mg, or when the content of Zr or Mg was less than 0.1 wt. %, even if other components met the requirements of the present invention, the bending strength of the final magnet was still relatively low. It could be determined that Zr or Mg was very important for the mechanical performance of the magnet in the present invention, and therefore the alloy needed to contain 0.1 wt. % of Mf element.

The proportion (volume ratio) of the amorphous grain boundary phase in the grain boundary phase within the range of 300 μm×300 μm of the sample was calculated by TEM bright field image and selected area electron diffraction results. The results were shown in Table 3.

TABLE 3

| No. | 1 | 2 | 3 | 4 | 5 | 6 | 7 | 8 | 9 | 10 | 11 |
|---|---|---|---|---|---|---|---|---|---|---|---|
| Propor- | 0.9 | 0.8 | 1.1 | 0.9 | 1.3 | 1.5 | 23.5 | 23.8 | 24.0 | 25.6 | 27.3 |
| tion | | | | | | | | | | | |
| (vol. %) | | | | | | | | | | | |

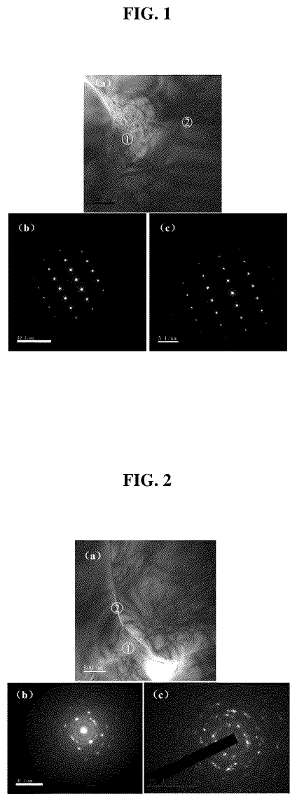

The bright field image of the grain boundary phase of the magnet in Experiment No. 2 was shown in FIG. 1(a), and the diffraction patterns of the triangular grain boundary phase between the three main phases and the thin layer grain boundary phase between the two main phases were shown in FIGS. 1(b) and (c), respectively.

The bright field image of the grain boundary phase of the magnet in Experiment No. 6 was shown in FIG. 2(a), and the diffraction patterns of the triangular grain boundary phase between the three main phases and the thin layer grain boundary phase between the two main phases were shown in FIGS. 2(b) and (c), respectively.

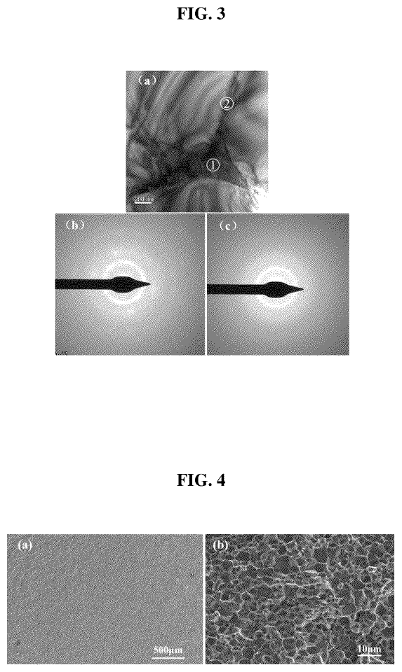

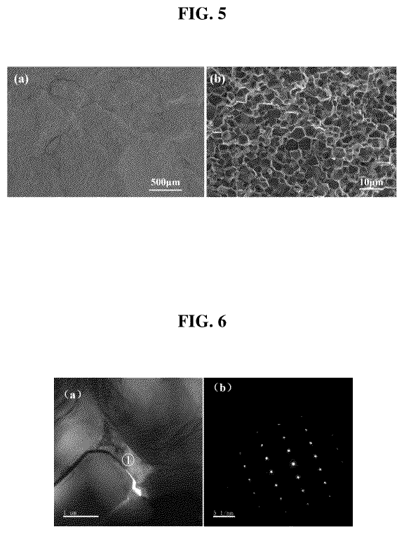

The bright field image of the grain boundary phase of the magnet in Experiment No. 10 was shown in FIG. 3(a), and the diffraction patterns of the triangular grain boundary phase between the three main phases and the thin layer grain boundary phase between the two main phases were shown in FIGS. 3(b) and (c), respectively.

From the TEM bright field images and diffraction patterns of the triangular grain boundary phase and thin layer grain boundary phase of the magnets in Experiment Nos. 2, 6, and 10, as well as the data in Table 3, it could be determined that when the alloy composition (Experiment No. 2) deviated from the composition of the present invention, the majority of the grain boundary phase of the magnet was a crystalline phase, and the proportion of the amorphous grain boundary phase was very small.

In Experiment No. 6, although other components of the magnet met the requirements of the present invention, the content of Zr or Mg element was low, the concentration of Zr and Mg atoms in the grain boundary phase was insufficient, and thus the amorphous formation ability of the liquid grain boundary phase was weak. Based on the diffraction pattern of Experiment No. 6 and the data in Table 3, it could be determined that the grain boundary phase of the magnet in Experiment No. 6 was polycrystalline, and the proportion of the amorphous grain boundary phase was still relatively small, resulting in a lower bending strength of the magnet.

When the alloy composition met the requirements of the present invention (Experiment No. 7-Experiment No. 11), the proportion of the amorphous grain boundary phase in the magnet increased significantly. Due to the significantly higher strength of the amorphous grain boundary phase compared to the crystalline grain boundary phase, crack propagation under stress could be effectively hindered, and thus the bending strength of the magnet was significantly improved. Comparing the fracture surfaces of the magnets in Experiment No. 6 and Experiment No. 10, it was found that the fracture surface of the magnet in Experiment No. 6 was relatively flat, and the type of fracture surface observed from its local magnified image was mainly intergranular fracture. The fracture surface of the magnet in Experiment No. 10 showed obvious traces of crack propagation in different directions, and the local magnified image also showed a significant increase in the proportion of transgranular fracture. This was due to the increase in the proportion of the amorphous grain boundary phase of the magnet in Experiment No. 10. The high-strength amorphous grain boundary phase hindered the propagation of cracks along the grain boundary phase, resulting in an increase in the proportion of transgranular fracture.

EPMA was used to analyze the grain boundary phase composition of the magnet in Experiment No. 10, and TEM samples were prepared using FIB. The structure of the grain boundary phase was analyzed using selected area electron diffraction. The experimental results were shown in Table 4.

TABLE 4
Content of each element component in the grain boundary phase (unit: wt. %)

| Grain | | | | | | | | | | | | | | |
|---|---|---|---|---|---|---|---|---|---|---|---|---|---|---|
| boundary | | | | | | | | | | | | | | |
| phase | State | Nd | Pr | Dy | Zr | Fe | Co | Al | Ga | B | O | S | N | C |
| 1 | Crystalline | 42.46 | 12.8 | 1.08 | 0.05 | 35.62 | 0.13 | 0.32 | 0.71 | 1.07 | 1.57 | 3.01 | 0 | 1.18 |
| 2 | Crystalline | 43.86 | 5.28 | 1.71 | 0 | 34.21 | 0.21 | 0.93 | 1.87 | 0.26 | 1.56 | 4.35 | 0.04 | 2.21 |
| 3 | Amorphous | 44.10 | 10.60 | 0.05 | 2.58 | 31.94 | 2.11 | 0.82 | 1.67 | 0.42 | 3.01 | 1.52 | 0.03 | 1.15 |
| 4 | Amorphous | 39.00 | 13.20 | 2.24 | 1.35 | 31.85 | 2.85 | 0.92 | 1.61 | 0.32 | 2.25 | 3.43 | 0.00 | 0.98 |
| 5 | Amorphous | 43.93 | 13.24 | 4.28 | 0.35 | 27.17 | 2.23 | 0.68 | 1.12 | 0.72 | 1.74 | 2.96 | 0.10 | 1.48 |

Through analysis of the composition of the amorphous and crystalline grain boundary phases, it was found that the amorphous grain boundary phase comprised three types of elements with large, medium, and small atomic radii simultaneously, and comprised ≥3 small-atomic-radius elements, ≥3 medium-atomic-radius elements, and ≥3 large-atomic-radius elements. By simultaneously analyzing the composition of multiple amorphous grain boundary phases, it was found that the content of the large-atomic-radius elements in the amorphous grain boundary phase was 30 wt. %-70.0 wt. %, the content of the medium-atomic-radius elements was 20.0 wt. %-65.0 wt. %, the content of the small-atomic-radius elements was 1.0 wt. %-15.0 wt. %, and the atomic radius elements comprised 0.2 wt. %-10.0 wt. % of Mf. By analyzing the composition of multiple grain boundary phases, it was found that when the grain boundary phase composition of the magnet did not meet the requirements of the present invention, the grain boundary phase could not be transformed into an amorphous state.

The present invention, based on the design principles of an amorphous alloy, enabled the elements that were prone to segregation at the grain boundary phase of the R-T-B magnet to simultaneously comprise three types of elements with different atomic radii: large, medium, and small radii. When the grain boundary phase comprised three elements with different atomic radii: large, medium, and small radii, the number of elements with different atomic radii, i.e. large, medium, and small atomic radii, in the grain boundary phase was ≥3, and the content of the large-atomic-radius elements was 30 wt. %-70.0 wt. %, and the large-atomic-radius elements comprised 0.2 wt. %-10.0 wt. % of Mf; the content of the medium-atomic-radius elements was 20.0 wt. %-65.0 wt. %; and the content of the small-atomic-radius elements was 1.0 wt. %-15.0 wt. %, its amorphous formation ability would be significantly improved, and therefore an amorphous state could also be obtained at a slower cooling rate after the second stage aging. By utilizing the significantly higher strength of an amorphous material compared to a crystalline material of the same composition, the ability of the magnetic grain boundary phase to resist crack propagation was improved, resulting in a high-strength R-T-B rare earth permanent magnet.

### Example 2

Raw materials with a purity of 99.9 wt. % or higher were taken according to a composition ratio and placed in a crucible in order of melting point from high to low. The furnace was evacuated until the vacuum degree reached 10⁻³-10⁻⁴ Pa and the dew point was below −50° C. Afterwards, the furnace was filled with argon gas to reach a pressure of 30 kPa, and heated to 1490° C. The raw materials were completely melted, and then kept at this temperature for 3 min. Afterwards, the temperature of an alloy liquid was lowered to 1450° C., kept at this temperature, and casted. The rotational speed of a copper roller was adjusted to 70 revolutions per minute, then the crucible was rotated at a certain speed to transport the molten alloy liquid through an intermediate package to a cooling roller for solidification, and then the resultant was dropped onto a water-cooled plate for cooling to prepare SC strips with different compositions.

An alloy powder was prepared from the SC strips by hydrogen decrepitation and jet milling. During the hydrogen decrepitation treatment, the hydrogen pressure inside a reaction vessel was adjusted to 0.05 MPa. During a hydrogen absorption reaction, if the pressure inside the reactor changes by no more than 0.5% within 10 minutes, it indicated the end of hydrogen absorption. After the hydrogen absorption reaction was completed, the temperature was raised to 550° C. while vacuuming, and the temperature was kept for 3 h to remove hydrogen gas from the alloy strips. Then, a hydrogen crushed coarse powder was obtained by cooling. The obtained coarse powder was placed in a jet milling equipment, the nozzle pressure was adjusted to 0.6 MPa, and the coarse powder was driven to collide with each other through a high-speed gas for crushing. The gas used in the jet milling is nitrogen gas. A sorting wheel and a cyclone separator of the jet milling equipment were controlled to adjust the particle size SMD of the powder to 3.0 μm.

FeS, Nd₂O₃, and Fe₃C powder particles with a particle size of 100 nm were mixed into the jet-milled powder to obtain a mixed powder. The relative mass consumption of the three powder particles to the jet-milled powder was 0.3 wt. %, 0.5 wt. %, and 0.2 wt. %, respectively.

After adding a lubricant and an antioxidant to the alloy powder, the alloy powder was press-molded in an oriented magnetic field using a conventional commercially available lubricant or antioxidant for protecting a magnetic powder. The lubricant used in the example was “Magnetic Powder Protective Lubricant 3# produced by Tianjin Yuesheng New Materials Research Institute”, and the antioxidant was “Neodymium Iron Boron Special Antioxidant 1# produced by Tianjin Yuesheng New Materials Research Institute”. The amount of the lubricant added was 0.08% of the mass of the alloy powder, and the amount of the antioxidant was 0.1% of the mass of the alloy powder.

The magnet was subjected to oriented molding with an orientation magnetic field of 5 T and a molding pressure of 5 MPa. After oriented molding, a compact was subjected to cold isostatic pressing at a pressure of 150 MPa. After oriented molding, the compact density was 3.6-4.0 g/cm³, and after cold isostatic pressing, the compact density was about 4.6 g/cm³.

The magnet was sintered densely using a vacuum sintering process. The vacuum sintering process was as follows: the vacuum degree was 10⁻³-10⁻⁴ Pa, the sintering temperature was 1090° C., the temperature holding time was 6 hours, and after the temperature holding process was completed, it was cooled by air cooling.

The sintered magnet was subjected to first stage aging at an aging temperature of 880° C., and the temperature holding time was 3 hours. After the temperature holding process was completed, it was cooled by air cooling.

After the first stage aging, the magnet was subjected to second stage aging at an aging temperature of 520° C., and the temperature holding time was 3 h. After the temperature holding process was completed, low-temperature argon gas at −20° C. was introduced into the furnace, and a cold air fan was started for rapid cooling. The cooling rate of the magnet was 60-70° C./minute.

After crushing the magnet, samples were taken from a core, and ICP was used to detect the composition of the magnet. TEM was used to analyze the grain boundary phase structure of the magnet. TEM samples were prepared using ion thinning and FIB, and the ion thinning time was less than 2 hours. EPMA was used to analyze the composition distribution of the magnet, and SEM was used to observe the microstructure of the magnet. The bending strength of the magnet was measured using a three-point bending method. Three-point bending samples were prepared by slicing the inner circle and double-sided grinding. The sample dimensions were 25 (±0.01) mm in length, 6 (±0.01) mm in width, and 5 (±0.01) mm in height. The height direction of the samples was parallel to the orientation direction of the magnet. The bending strength of 10 samples in each group was measured and the average value was calculated. A three-point bending indenter was a cylinder with a diameter of 5 mm, the diameter of two supporting columns was 5 mm, the span between support points was 14.5 mm, and the pressing speed of the indenter was 0.1 mm/minute. The magnet was processed into a cylinder with a diameter of φ10×10, wherein the height direction of the cylinder was the orientation direction of the magnet. A NIM magnetic performance tester was used to test the magnetic performance of the magnet.

The components of the magnets of Experiment No. 12-Experiment No. 15 were shown in Table 5. The components of the magnets of each experiment group were expressed by mass percentages, where A₁ represented the total content of small-atomic-radius elements (O, S, H, N, and C) in the magnet except element B.

TABLE 5
Components of a magnet, unit: wt. %

| | | | | | | | | | | | | Component |
|---|---|---|---|---|---|---|---|---|---|---|---|---|
| No. | Nd | Pr | Zr | Fe | Co | Al | Nb | Ga | Cu | B | A₁ | requirements |
| 12 | 28.6 | 3.2 | / | Bal | 0.3 | 0.2 | 0.1 | 0.2 | 0.1 | 0.96 | 0.39 | Not satisfied |
| 13 | 28.6 | 3.2 | 0.05 | Bal | 0.3 | 0.2 | 0.1 | 0.2 | 0.1 | 0.96 | 0.39 | Not satisfied |
| 14 | 28.6 | 3.2 | 0.5 | Bal | 0.3 | 0.2 | 0.1 | 0.2 | 0.1 | 0.96 | 0.39 | Satisfied |
| 15 | 28.6 | 3.2 | 0.9 | Bal | 0.3 | 0.2 | 0.1 | 0.2 | 0.1 | 0.96 | 0.39 | Not satisfied |

The three-point bending method was used to test the bending strength of the magnet, 10 data points were tested for each group, and the average value was calculated. NIM was used to test the magnetic performance, and the results were shown in Table 6.

TABLE 6

| No. | 12 | 13 | 14 | 15 |
|---|---|---|---|---|
| Bending strength | 468 | 475 | 605 | 596 |
| (MPa) | | | | |
| Residual | 13.7 | 13.7 | 13.65 | 13.58 |
| magnetism Br | | | | |
| (kGs) | | | | |
| Coercivity Hcj | 16.0 | 15.8 | 15.3 | 13.8 |
| (kOe) | | | | |

The proportion (volume ratio) of the amorphous grain boundary phase in the sample within the range of 300 μm×300 μm was statistically analyzed using the TEM bright field image and selected area electron diffraction results. The results were shown in Table 7.

TABLE 7

| No. | 12 | 13 | 14 | 15 |
|---|---|---|---|---|
| Proportion | 1.1 | 1.3 | 24.1 | 23.9 |
| (vol. %) | | | | |

When Mf element in the alloy was enriched in the grain boundary phase, it could significantly enhance the amorphous formation ability of the liquid grain boundary phase, thereby promoting the transformation of the liquid grain boundary phase into an amorphous state during the cooling process of the second stage aging. In Experiment No. 12 and Experiment No. 13, the content of Mf element was low (<0.1 wt. %), and its concentration in the grain boundary phase was low. According to the data in Table 7, it can be determined that the proportion of the amorphous grain boundary phase was low after the second stage aging, and the bending strength of the magnet was poor. When the content of Mf element was within the recommended range of the present invention, the proportion of the amorphous grain boundary phase in the magnet was significantly increased after the second stage aging. With the high strength of the amorphous grain boundary phase, the mechanical performance of the magnet could be improved, and therefore the bending strength value of the magnet was also increased. However, it was worth noting that as the wettability between the amorphous grain boundary phase and the main phase of the magnet was lower than that between the FCC structure grain boundary phase and the main phase, the generation of the amorphous grain boundary phase would lead to a certain degree of reduction in the coercivity of the magnet. When the Mf element content of the magnet was too high (>0.8 wt. %), there was no significant improvement in the amorphous grain boundary phase and the bending strength of the magnet, but the decrease in residual magnetism and coercivity of the magnet would increase, and the magnetic performance would significantly decrease. Therefore, in order to ensure the mechanical and magnetic performance of the magnet in the present invention, the Mf element content was 0.1 wt. %-0.8 wt. %.

### Example 3

Raw materials with a purity of 99.9 wt. % or higher were taken according to a composition ratio and placed in a crucible in order of melting point from high to low. The furnace was evacuated until the vacuum degree reached 10⁻³-10⁻⁴ Pa and the dew point was below −50° C. Afterwards, the furnace was filled with argon gas to reach a pressure of 30 kPa, and heated to 1490° C. The raw materials were completely melted, and then kept at this temperature for 3 minutes. Afterwards, the temperature of an alloy liquid was lowered to 1450° C., kept at this temperature, and casted. The rotational speed of a copper roller was adjusted to 70 revolutions per minute, then the crucible was rotated at a certain speed to transport the molten alloy liquid through an intermediate package to a cooling roller for solidification, and then the resultant was dropped onto a water-cooled plate for cooling to prepare SC alloy strips.

An alloy powder was prepared from the SC strips by hydrogen decrepitation and jet milling. During the hydrogen decrepitation treatment, the hydrogen pressure inside a reaction vessel was adjusted to 0.05 MPa. During a hydrogen absorption reaction, if the pressure inside the reactor changes by no more than 0.5% within 10 minutes, it indicated the end of hydrogen absorption. After the hydrogen absorption reaction was completed, the temperature was raised to 550° C. while vacuuming, and the temperature was kept for 3 hours to remove hydrogen gas from the alloy strips. Then, a hydrogen crushed coarse powder was obtained by cooling. The obtained coarse powder was placed in a jet milling equipment, the nozzle pressure was adjusted to 0.6 MPa, and the coarse powder was driven to collide with each other through a high-speed gas for crushing. The gas used in the jet milling is nitrogen gas. A sorting wheel and a cyclone separator of the jet milling equipment were controlled to adjust the particle size SMD of the powder to 3.0 μm.

The jet-milled powder was mixed with a powder containing small-atomic-radius elements, and the particle size of the small-atomic-radius element powder was 100 nm.

After adding a lubricant and an antioxidant to the alloy powder, the alloy powder was press-molded in an oriented magnetic field using a conventional commercially available lubricant or antioxidant for protecting a magnetic powder. The lubricant used in the example was “Magnetic Powder Protective Lubricant 3# produced by Tianjin Yuesheng New Materials Research Institute”, and the antioxidant was “Neodymium Iron Boron Special Antioxidant 1# produced by Tianjin Yuesheng New Materials Research Institute”. The amount of the lubricant added was 0.08% of the mass of the alloy powder, and the amount of the antioxidant was 0.1% of the mass of the alloy powder.

The magnet was subjected to oriented molding with an orientation magnetic field of 5 T and a molding pressure of 5 MPa. After oriented molding, a compact was subjected to cold isostatic pressing at a pressure of 150 MPa. After oriented molding, the compact density was 3.6-4.0 g/cm³, and after cold isostatic pressing, the compact density was about 4.6 g/cm³.

The magnet was sintered densely using a vacuum sintering process. The vacuum sintering process was as follows: the vacuum degree was 10⁻³-10⁻⁴ Pa, the sintering temperature was 1090° C., the temperature holding time was 6 h, and after the temperature holding process was completed, it was cooled by air cooling.

The sintered magnet was subjected to first stage aging at an aging temperature of 880° C., and the temperature holding time was 3 hours. After the temperature holding process was completed, it was cooled by air cooling.

After the first stage aging, the magnet was subjected to second stage aging at an aging temperature of 520° C., and the temperature holding time was 3 hours. After the temperature holding process was completed, low-temperature argon gas at −20° C. was introduced into the furnace, and a cold air fan was started for rapid cooling. The cooling rate of the magnet was 60-70° C./min.

After crushing the magnet, samples were taken from a core, and ICP was used to detect the composition of the magnet. TEM was used to analyze the grain boundary phase structure of the magnet. TEM samples were prepared using ion thinning and FIB, and the ion thinning time was less than 2 hours. EPMA was used to analyze the composition distribution of the magnet, and SEM was used to observe the microstructure of the magnet. The bending strength of the magnet was measured using a three-point bending method. Three-point bending samples were prepared by slicing the inner circle and double-sided grinding. The sample dimensions were 25 (±0.01) mm in length, 6 (±0.01) mm in width, and 5 (±0.01) mm in height. The height direction of the samples was parallel to the orientation direction of the magnet. The bending strength of 10 samples in each group was measured and the average value was calculated. A three-point bending indenter was a cylinder with a diameter of 5 mm, the diameter of two supporting columns was 5 mm, the span between support points was 14.5 mm, and the pressing speed of the indenter was 0.1 mm/min.

In the present example, the composition of the alloy SC strips was the same as in Experiment No. 10. The types and contents of the small-atomic-radius element powders mixed in the jet-milled powder in Experiment No. 16-Experiment No. 18 were shown in Table 8.

TABLE 8

| Experiment No. | FeS | Nd₂O₃ | Fe₃C |
|---|---|---|---|
| 16 | 0.3 wt. % | 0.5 wt. % | 0.2 wt. % |
| 17 | 0.3 wt. % | / | 0.2 wt. % |
| 18 | / | / | / |

The components of the magnets of Experiment No. 16-Experiment No. 18 were shown in Table 9. The components of the magnets of each experiment group were expressed by mass ratio, where A₁ represented the total content of small-atomic-radius elements (O, S, H, N, and C) in the magnet except element B.

TABLE 9

| | | | | | | | | | | | Component |
|---|---|---|---|---|---|---|---|---|---|---|---|
| No. | Nd | Pr | Dy | Zr | Fe | Co | Al | Ga | B | A₁ | requirements |
| 16 | 28.6 | 3.2 | 0.15 | 0.2 | Bal | 0.3 | 0.2 | 0.2 | 0.96 | 0.39 | Satisfied |
| 17 | 28.6 | 3.2 | 0.15 | 0.2 | Bal | 0.3 | 0.2 | 0.2 | 0.96 | 0.33 | Satisfied |
| 18 | 28.6 | 3.2 | 0.15 | 0.2 | Bal | 0.3 | 0.2 | 0.2 | 0.96 | 0.20 | Not satisfied |

The three-point bending method was used to test the bending strength of the magnet, 10 data points were tested for each group, and the average value was calculated. The proportion (volume ratio) of the amorphous grain boundary phase in the sample within the range of 300 μm×300 μm was statistically analyzed using the TEM bright field image and selected area electron diffraction results. The results were shown in Table 10.

TABLE 10

| No. | 16 | 17 | 18 |
|---|---|---|---|
| Bending strength | 596 | 582 | 465 |
| (MPa) | | | |
| Volume ratio (vol. %) | 26.1 | 25.2 | 0.9 |

Small-atomic-radius elements could enhance the amorphous formation ability of the grain boundary phase of the magnet. Multiple elements with different atomic radii could enhance the viscosity of a liquid grain boundary phase, increase the crystallization resistance of the liquid grain boundary phase during cooling, and promote the formation of an amorphous grain boundary phase. The total content of the small-atomic-radius elements in the magnets from Experiment No. 16-Experiment No. 17 met the requirements, but as the type and content of the small-atomic-radius elements increased, the liquid grain boundary phase was more likely to form an amorphous phase during cooling, enhancing the mechanical performance of the magnet. According to the data in Table 10, the bending strength of the magnet of Experiment No. 16 was better. In Experiment No. 18, no small-atomic-radius element powder was added. During the preparation of the magnet, the residual amount of the small-atomic-radius elements was 0.20 wt. %, which did not meet the requirements of the present invention, therefore the amorphous formation ability of the grain boundary phase was weak, and it was easier to form a crystalline grain boundary phase when cooled after the second stage aging. The proportion of an amorphous phase was too low, resulting in poor mechanical performance of the magnet.

### Example 4

Raw materials with a purity of 99.9 wt. % or higher were taken according to a composition ratio and placed in a crucible in order of melting point from high to low. The furnace was evacuated until the vacuum degree reached 10⁻³-10⁻⁴ Pa and the dew point was below −50° C. Afterwards, the furnace was filled with argon gas to reach a pressure of 30 kPa, and heated to 1490° C. The raw materials were completely melted, and then kept at this temperature for 3 min. Afterwards, the temperature of an alloy liquid was lowered to 1450° C., kept at this temperature, and casted. The rotational speed of a copper roller was adjusted to 70 revolutions per minute, then the crucible was rotated at a certain speed to transport the molten alloy liquid through an intermediate package to a cooling roller for solidification, and then the resultant was dropped onto a water-cooled plate for cooling to prepare SC alloy strips.

An alloy powder was prepared from the SC strips by hydrogen decrepitation and jet milling. During the hydrogen decrepitation treatment, the hydrogen pressure inside a reaction vessel was adjusted to 0.05 MPa. During a hydrogen absorption reaction, if the pressure inside the reactor changes by no more than 0.5% within 10 minutes, it indicated the end of hydrogen absorption. After the hydrogen absorption reaction was completed, the temperature was raised to 550° C. while vacuuming, and the temperature was kept for 3 h to remove hydrogen gas from the alloy strips. Then, a hydrogen crushed coarse powder was obtained by cooling. The obtained coarse powder was placed in a jet milling equipment, the nozzle pressure was adjusted to 0.6 MPa, and the coarse powder was driven to collide with each other through a high-speed gas for crushing. The gas used in the jet milling is nitrogen gas. A sorting wheel and a cyclone separator of the jet milling equipment were controlled to adjust the particle size SMD of the powder to 3.0 μm.

In this example, Experiment No. 19 used a mixed powder obtained by mixing FeS, Nd₂O₃ and Fe₃C powder particles with a particle size of 100 nm into the jet-milled powder, and the relative mass amounts of the three powder particles to the jet-milled powder were 0.3 wt. % 0.5 wt. % and 0.2 wt. %, respectively. In Experiment No. 20, FeS, Nd₂O₃, and Fe₃C with a particle size of 100 nm were added to a melted raw material. The mass amounts of the three powder particles were 0.3 wt. %, 0.5 wt. % and 0.2 wt. %, respectively.

After adding a lubricant and an antioxidant to the alloy powder, the alloy powder was press-molded in an oriented magnetic field using a conventional commercially available lubricant or antioxidant for protecting a magnetic powder. The lubricant used in the example was “Magnetic Powder Protective Lubricant 3#produced by Tianjin Yuesheng New Materials Research Institute”, and the antioxidant was “Neodymium Iron Boron Special Antioxidant 1#produced by Tianjin Yuesheng New Materials Research Institute”. The amount of the lubricant added was 0.08% of the mass of the alloy powder, and the amount of the antioxidant was 0.1% of the mass of the alloy powder.

The magnet was subjected to oriented molding with an orientation magnetic field of 5 T and a molding pressure of 5 MPa. After oriented molding, a compact was subjected to cold isostatic pressing at a pressure of 150 MPa. After oriented molding, the compact density was 3.6-4.0 g/cm³, and after cold isostatic pressing, the compact density was about 4.6 g/cm³.

The magnet was sintered densely using a vacuum sintering process. The vacuum sintering process was as follows: the vacuum degree was 10⁻³-10⁻⁴ Pa, the sintering temperature was 1090° C., the temperature holding time was 6 hours, and after the temperature holding process was completed, it was cooled by air cooling.

The sintered magnet was subjected to first stage aging at a temperature of 880° C., and the temperature holding time was 3 hours. After the temperature holding process was completed, it was cooled by air cooling.

After the first stage aging, the magnet was subjected to second stage aging at an aging temperature of 520° C., and the temperature holding time was 3 hours. After the temperature holding process was completed, low-temperature argon gas at −20° C. was introduced into the furnace, and a cold air fan was started for rapid cooling. The cooling rate of the magnet was 60-70° C./min.

After crushing the magnet, samples were taken from a core, and ICP was used to detect the composition of the magnet. TEM was used to analyze the grain boundary phase structure of the magnet. TEM samples were prepared using ion thinning and FIB, and the ion thinning time was less than 2 hours. EPMA was used to analyze the composition distribution of the magnet, and SEM was used to observe the microstructure of the magnet. The bending strength of the magnet was measured using a three-point bending method. Three-point bending samples were prepared by slicing the inner circle and double-sided grinding. The sample dimensions were 25 (±0.01) mm in length, 6 (±0.01) mm in width, and 5 (±0.01) mm in height. The height direction of the samples was parallel to the orientation direction of the magnet. The bending strength of 10 samples in each group was measured and the average value was calculated. A three-point bending indenter was a cylinder with a diameter of 5 mm, the diameter of two supporting columns was 5 mm, the span between support points was 14.5 mm, and the pressing speed of the indenter was 0.1 mm/min.

In the present example, the composition of other alloy elements was the same as that of Experiment No. 10, and the components of the magnet in Experiment Nos. 19 and 20 were shown in Table 11.

TABLE 11

| | | | | | | | | | | | Component |
|---|---|---|---|---|---|---|---|---|---|---|---|
| No. | Nd | Pr | Dy | Zr | Fe | Co | Al | Ga | B | A1 | requirements |
| 19 | 28.6 | 3.2 | 0.15 | 0.2 | Bal | 0.3 | 0.2 | 0.2 | 0.96 | 0.39 | Satisfied |
| 20 | 28.6 | 3.2 | 0.15 | 0.2 | Bal | 0.3 | 0.2 | 0.2 | 0.96 | 0.38 | Satisfied |

The three-point bending method was used to test the bending strength of the magnet, 10 data points were tested for each group, and the average value was calculated. The proportion (volume ratio) of the amorphous grain boundary phase in the sample within the range of 300 μm×300 μm was statistically analyzed using the TEM bright field image and selected area electron diffraction results. The results were shown in Table 12.

TABLE 12

| No. | 19 | 20 |
|---|---|---|
| Bending strength (MPa) | 598 | 456 |
| Volume ratio (vol. %) | 26.3 | 0.82 |

The small-atomic-radius elements, due to their small atomic size, were prone to be solid-dissolving in the main phase grains of the magnet. The segregation concentration of the small-atomic-radius elements added during the melting stage was relatively low in the grain boundary phase. Experiment No. 20 adopted a method of adding the small-atomic-radius elements during the melting stage. Although the content of the small-atomic-radius elements in the final alloy still met the concentration requirements of the present invention, most of them were solid-dissolved into the main phase. Therefore, the concentration of the small-atomic-radius elements in the grain boundary phase was decreased, and the amorphous formation ability of the liquid grain boundary phase was weakened. According to Table 12 and the TEM bright field image of the magnet and the selected area electron diffraction results of Experiment No. 20, the proportion of the amorphous phase in the final grain boundary phase decreased, and the mechanical performance of the magnet also decreased as a result. Therefore, in the present invention, a method of mixing nanometer-scale powder particles containing small-atomic-radius elements with a jet-milled magnetic powder was used to ensure that most of the small-atomic-radius elements can be enriched in the grain boundary phase of the magnet. Increasing the viscosity of the liquid grain boundary phase to enhance its amorphous formation ability promotes the transformation of the liquid grain boundary phase into an amorphous state after second stage aging. The mechanical performance of the magnet was improved by means of the high strength of the amorphous grain boundary.

1. A high-strength R-T-B rare earth permanent magnet having an amorphous grain boundary phase, wherein 29.0 wt. %-34.0 wt. % of large-atomic-radius elements have the atomic radius r satisfying r≥0.16 nm, the large-atomic-radius elements comprise three or more of Nd, Pr, Dy, Tb, Ho, La, Ce, Gd, Er, Mg, and Zr, the large-atomic-radius elements contain 0.1 wt. %-0.8 wt. % of Mf, and Mf is any one or two of Zr and Mg;
1.05 wt. %-1.65 wt. % of small-atomic-radius elements have the atomic radius r satisfying r≤0.12 nm, the small-atomic-radius elements comprise three or more of S, C, H, N, O, F, and B and comprise 0.8 wt. %-1.1 wt. % of boron element; and the total content C1 of the small-atomic-radius elements satisfies 0.25 wt. %≤[C1]−[B]≤0.55 wt. %, wherein [C1] and [B] are C1 and B contents expressed as weight percentages; and
the balance are medium-atomic-radius elements with the atomic radius r satisfying 0.12 nm<r<0.16 nm and other unavoidable impurities, the medium-atomic-radius elements comprise three or more of Fe, Co, Ti, Al, Nb, Zn, Ga, W, Mn, Mo, V, Si, P, and Cu, the medium-atomic-radius elements at least comprises 60.0 wt. % of TM, and the TM is at least one of Fe and Co, and the content of the medium-atomic-radius elements other than the TM is ≥0.2 wt. %.

2. The high-strength R-T-B rare earth permanent magnet having an amorphous grain boundary phase of claim 1, wherein the total content of the small-atomic-radius elements except boron element is 0.3-0.5 wt. %.

3. The high-strength R-T-B rare earth permanent magnet having an amorphous grain boundary phase of claim 1, wherein the content of the medium-atomic-radius elements except the TM is 0.2-1.5 wt. %.

4. The high-strength R-T-B rare earth permanent magnet having an amorphous grain boundary phase of claim 1, wherein the magnet comprises a main phase R₂T₁₄B and a grain boundary phase, and the grain boundary phase consists of a crystalline grain boundary phase and an amorphous grain boundary phase; and
when amorphous grain boundaries are the same, the amorphous grain boundaries comprise three types of elements having large, medium and small atomic radius, and the number of the comprised small-atomic-radius elements is ≥3, the number of the medium-atomic-radius elements is ≥3, and the number of the large-atomic-radius elements is ≥3.

5. The R-T-B rare earth permanent magnet having an amorphous grain boundary phase of claim 4, wherein the proportion of the amorphous grain boundary phase in the grain boundary phase of the magnet is 20 vol. % or more.

6. The R-T-B rare earth permanent magnet having an amorphous grain boundary phase of claim 4, wherein the content of the large-atomic-radius elements in the amorphous grain boundary phase of the magnet is 30 wt. %-70.0 wt. %, and the large-atomic-radius elements comprise 0.2 wt. %-10.0 wt. % of Mf; and the content of the medium-atomic-radius elements is 20.0 wt. %-65.0 wt. %, and the content of the small-atomic-radius elements is 1.0 wt. %-15.0 wt. %.

7. The R-T-B rare earth permanent magnet having an amorphous grain boundary phase of claim 1, wherein the high-strength R-T-B rare earth permanent magnet having an amorphous grain boundary phase is prepared by one of the following methods:
(1) the magnet does not comprise Mg element: melting and spinning SC strips according to a composition ratio, and preparing an alloy powder by hydrogen decrepitation and jet milling, mixing the alloy powder with a powder comprising the small-atomic-radius elements, press-molding the mixed powder in an oriented magnetic field and isostatically pressing the mixed powder to prepare a compact, and vacuum-sintering the compact is, and subjecting the compact to a first stage aging and a second stage aging to prepare the R-T-B rare earth permanent magnet having an amorphous boundary phase; and
(2) the magnet comprises Mg element: melting and spinning SC strips according to a composition ratio of elements except Mg, preparing an alloy powder by hydrogen decrepitation and jet milling, mixing the alloy powder with a Mg particulate and a powder comprising the small-atomic-radius elements, press-molding the mixed powder in an oriented magnetic field, and isostatically pressing the mixed powder to prepare a compact, and vacuum-sintering the compact, and subjecting the compact to a first stage aging and a second stage aging to prepare the R-T-B rare earth permanent magnet having an amorphous boundary phase.

8. The R-T-B rare earth permanent magnet having an amorphous grain boundary phase of claim 7, wherein the powder comprising the small-atomic-radius elements is one or more of powders comprising S, C, O or F element, and the particle size of the powder comprising the small-atomic-radius elements is within 500 nm.

9. The R-T-B rare earth permanent magnet having an amorphous grain boundary phase of claim 7, wherein in the method (2), the Mg particulate is a pure metal particle or a magnesium oxide particle, and the particle size of the Mg particulate is within 500 nm.

10. The R-T-B rare earth permanent magnet having an amorphous grain boundary phase of claim 7, wherein in the method (1) or method (2), cooling is performed at a cooling rate of ≥60° C./min after the second stage aging.
